(19) United States
(12) Patent Application Publication
(10) Pub. No.: US 2025/0314889 A1
(43) Pub. Date: Oct. 9, 2025

(54) INCREASING THE EFFICIENCY AND REDUCING SEE-THROUGH ARTIFACTS OF REFLECTIVE WAVEGUIDES

(71) Applicant: GOOGLE LLC, Mountain View, CA (US)

(72) Inventor: Shreyas Potnis, Kitchener (CA)

(21) Appl. No.: 18/865,056

(22) PCT Filed: May 18, 2023
(86) PCT No.: PCT/US2023/022759

§ 371 Date: Nov. 12, 2024

Related U.S. Application Data
(60) Provisional application No. 63/343,235, filed on May 18, 2022.

(51) Int. Cl. G02B 27/01; G03H 1/02

(52) U.S. Cl. CPC G02B 27/0172; G03H 1/02; G02B 2027/0174; G02B 2027/0178; G03H 2260/12

(57) ABSTRACT

A waveguide including an incoupler, an outcoupler, and an exit pupil expander. The exit pupil expander is disposed in a light propagation path between the incoupler and the outcoupler. At least one of the outcoupler or the exit pupil expander has one or more holograph-based reflective couplers.

### BACKGROUND

In near-to-eye display (NED) devices (e.g., augmented reality glasses, mixed reality glasses, virtual reality headsets, and the like), light from an image source is generally coupled into, for example, a waveguide-based optical combiner (also referred to herein as a “waveguide” or “waveguide combiner”) by an optical input coupling element, such as an in-coupling grating, mirror, or a combination thereof (i.e., an “incoupler”). The incoupler can be formed on a surface, or multiple surfaces, of the waveguide combiner or disposed within the waveguide combiner. Once the light beams have been coupled into the waveguide combiner, the light beams are “guided” through the waveguide combiner, typically by multiple instances of total internal reflection (TIR) or by a coated or uncoated waveguide surface(s). The guided light beams are then directed out of the waveguide combiner by an output optical coupling (i.e., an “outcoupler”), which can also take the form of an optical grating, mirror, or a combination thereof. The outcoupler directs the light at an eye-relief distance from the waveguide combiner, forming an exit pupil within which a virtual image generated by the image source can be viewed by a user of the display device. In many instances, an exit pupil expander is arranged in an intermediate stage between the incoupler and outcoupler to receive light that is coupled into the waveguide combiner by the incoupler, expand the light, and redirect the light towards the outcoupler. The exit pupil expander can also take the form of an optical grating, mirror, or a combination thereof.

### SUMMARY OF EMBODIMENTS

In accordance with one aspect, a waveguide includes an incoupler, and outcoupler, and an exit pupil expander. The exit pupil expander is disposed in a light propagation path between the incoupler and the outcoupler. At least one of the outcoupler or the exit pupil expander includes one or more holograph-based reflective couplers.

In at least some embodiments, the one or more holograph-based reflective couplers are one-dimension (1D) Bragg optical devices.

In at least some embodiments, the one or more holograph-based reflective couplers are disposed within a photopolymer layer of the at least one of the outcoupler or the exit pupil expander.

In at least some embodiments, the waveguide further includes a layer of photopolymer with the one or more holograph-based reflective couplers disposed between two molded optic layers with complementary ridges.

In at least some embodiments, at least one of the outcoupler or the exit pupil expander includes a reflective array comprising a plurality of facets.

In at least some embodiments, the one or more holograph-based reflective couplers are formed on the plurality of facets.

In at least some embodiments, at least one of the outcoupler or the exit pupil expander further includes a first waveguide portion comprising a first portion of the reflective array, and a second waveguide portion comprising a second portion of the reflective array. The first waveguide portion is mated with the second waveguide portion.

In at least some embodiments, the first waveguide portion is adhered to the second waveguide portion.

In at least some embodiments, at least one of the outcoupler or the exit pupil expander further includes a photopolymer layer disposed between the first portion of the reflective array and the second portion of the reflective array.

In at least some embodiments, the first waveguide portion includes a first plurality of wedges including a first plurality of primary facets and a first plurality of secondary facets, and wherein the second waveguide portion includes a second plurality of wedges, corresponding to the first plurality of wedges, including a second plurality of primary facets and a second plurality of secondary facets.

In at least some embodiments, the photopolymer layer is disposed on at least one of the first plurality of primary facets and the second plurality of primary facets or the second plurality of primary facets and the second plurality of secondary facets.

In at least some embodiments, the one or more holograph-based reflective couplers are formed in one or more portions of the photopolymer layer disposed on one or more facets of at least one of the first plurality of primary facets or the second plurality of primary facets.

In at least some embodiments, the one or more holograph-based reflective couplers are spectrally and angularly multiplexed.

In at least some embodiments, the one or more holograph-based reflective couplers each include a frequency comb including a plurality of narrowband one-dimensional Bragg optical devices.

In at least some embodiments, the one or more holograph-based reflective couplers each are each tuned to a fraction of a broadband spectrum of light.

In at least some embodiments, the outcoupler includes the one or more holograph-based reflective couplers.

In at least some embodiments, the exit pupil expander includes the one or more holograph-based reflective couplers.

In accordance with another aspect, a waveguide includes an incoupler, and outcoupler, and an exit pupil expander. The exit pupil expander is disposed in a light propagation path between the incoupler and the outcoupler. At least one of the outcoupler or the exit pupil expander includes a first optic layer, a second optic layer, and a plurality of holograph-based reflective couplers disposed between the first optic layer and the second optic layer on complementary portions of the first optic layer and the second optic layer.

In at least some embodiments, the complementary portions of the first optic layer and the second optic layer are ridges

In accordance with another aspect, a near-eye display system includes an eyeglass frame, an ophthalmic lens implementing the waveguide described above and herein.

In accordance with another aspect, a method is disclosed for operating the near-eye display system described above and herein.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates one example of a waveguide configuration in accordance with at least some embodiments.

FIG. 2 illustrates one example of see-through artifacts caused by couplers of an exit pupil expander (EPE) and an outcoupler (OC) of a waveguide implemented in an eyeglass-type near-eye display frame.

FIG. 3 illustrates one example of the tension between the efficiency and geometry of couplers in the EPE region and the OC region of a waveguide.

FIG. 4 is a chart showing the relationship between coupler efficiency and coupler position in conventional EPE and OC configurations.

FIG. 5 illustrates an example display system with an integrated laser projection system in accordance with some embodiments.

FIG. 6 illustrates an example diagram of a waveguide for directing display light representing images onto the eye of a user via an eyewear display in accordance with some embodiments.

FIG. 7 illustrates a cross-section of a region in the waveguide of FIG. 6 comprising a reflective array having facets/couplers implementing one or more holographic 1D Bragg optical devices in accordance with some embodiments.

FIG. 8 illustrates a fabrication method for the waveguide region of FIG. 7 in accordance with some embodiments.

FIG. 9 illustrates a system for holographically recording the 1D Bragg optical device of FIG. 7 in accordance with some embodiments.

FIG. 10 is a flow diagram illustrating an example method of fabricating the waveguide region of FIG. 7 in accordance with some embodiments.

FIG. 11 is a flow diagram illustrating an example method of operating a near-eye display to project display light from a display source toward an eye of a user using the waveguide configuration of FIG. 7 in accordance with some embodiments.

### DETAILED DESCRIPTION

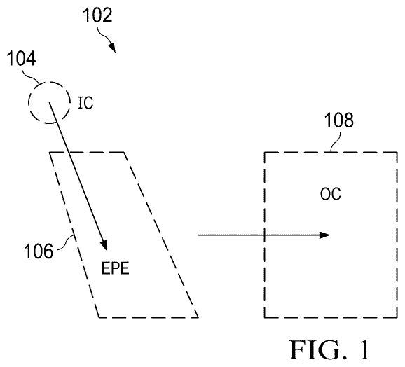

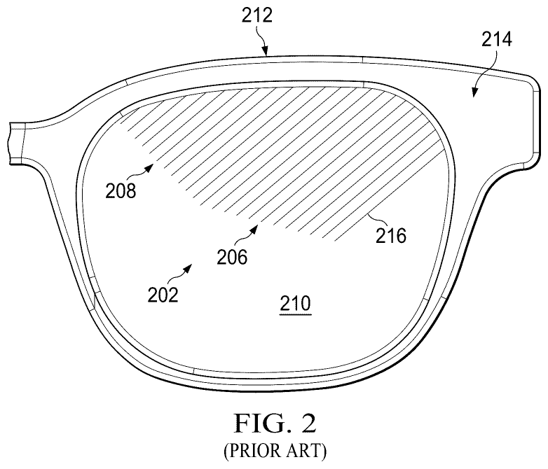

A waveguide is often used in NED devices to provide a view of the real world overlayed with static imagery or video (recorded or rendered). One type of waveguide combiner is a facet/reflective waveguide (herein referred to as a “reflective-based waveguide” or a “waveguide” for brevity) that implements partially reflective mirrors to direct light into a user's eye. As shown in FIG. 1, a waveguide 102 typically employs an incoupler (IC) 104 to receive display light, an exit pupil expander (EPE) 106 to increase the size of the display exit pupil, and an outcoupler (OC) 108 to direct the resulting display light toward a user's eye. However, the individual facets/couplers in reflective waveguides that perform pupil expansion in the EPE region and outcoupling in the OC region typically are highly visible and often can be distracting to the user. For example, FIG. 2 shows an example of an ophthalmic lens 210 housed within an eyeglass-type near-eye display frame 212 (that is, an “eyeglass frame” herein referred to as “frame 212” for brevity). In this example, a waveguide 202 is employed within the ophthalmic lens 210 such that an IC (not shown) is situated within a temple region 214 of the frame 212. It should be understood that only a portion of the frame 212 is shown for clarity. As illustrated by FIG. 2, the individual facets/couplers 216 in the waveguide 202 that perform pupil expansion in the EPE 206 region and outcoupling in the OC 208 region are highly visible to both the user and individuals looking at the user.

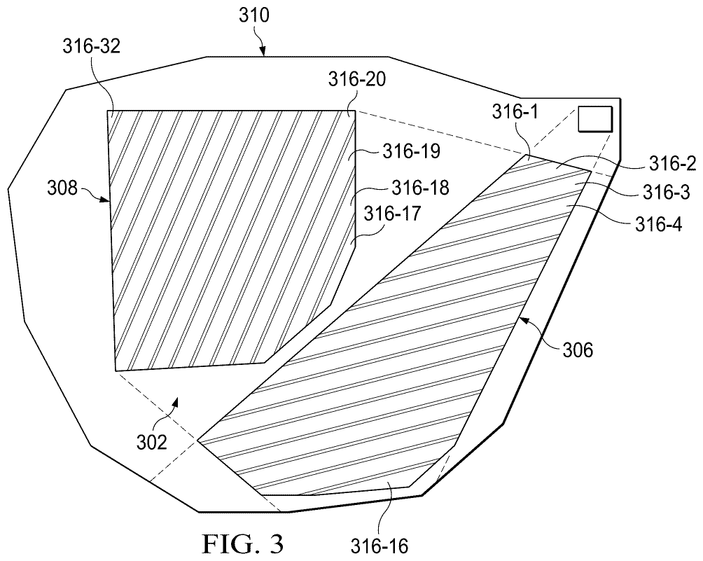

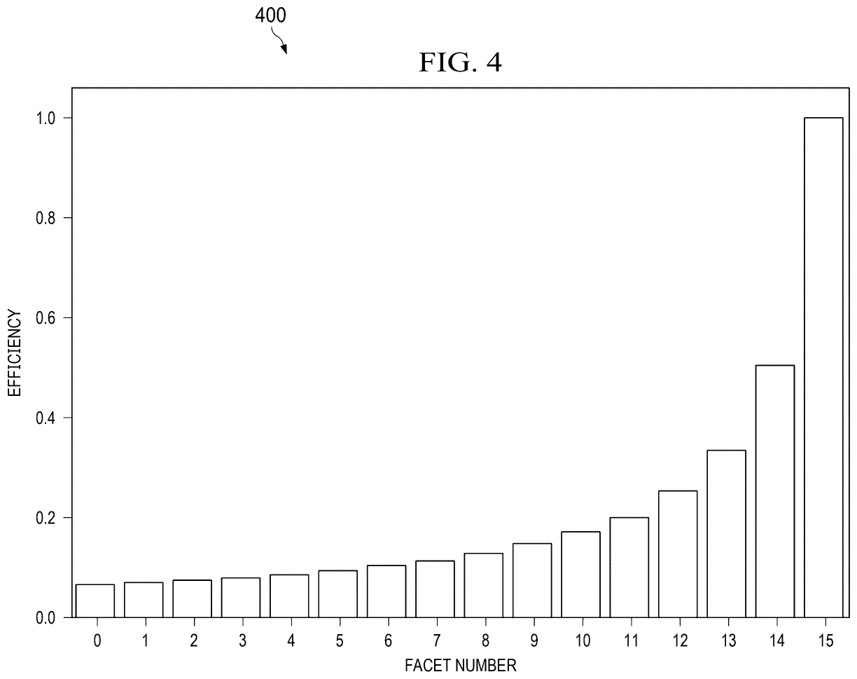

As such, to achieve all-day wearability for eyeglass-type near-eye displays with relatively small power and thermal budgets, the waveguide couplers should, in at least some configurations, be relatively efficient, such as 2.5% pupil efficiency or more, to necessitate efficient OC and EPE couplers while also mitigating the visibility of such couplers. However, achieving a balance between efficiency and visibility of the couplers can be difficult to achieve. FIG. 3 and FIG. 4 illustrate the tension between efficiency and geometry (and thus visibility) of couplers in the EPE region and the OC region of a waveguide. For example, FIG. 3 illustrates a waveguide 302 having an ophthalmic lens form 310 with an EPE 306 having a number of couplers 316 (illustrated as couplers 316-1 to 316-16) and an OC 308 having a number of couplers 312 (illustrated as couplers 316-17 to 316-32). It will be appreciated that as the light gets extracted from each coupler 316 in the EPE 306 and then OC 308, the remaining light is depleted. Thus, each successive facet or coupler needs to have a higher efficiency to have the same degree of light extraction, as illustrated by the chart 400 in FIG. 4. For example, the chart 400 shows that the last coupler 316-16 of the EPE 306 (or the last coupler 316-32 of the OC 308) needs to have an efficiency of 1 to obtain the same degree of light efficiency as the first coupler 316-1 of the EPE 306 (or the first coupler 316-17 of the OC 308) have an efficiency of approximately 7.5%. However, depending on the geometry of the couplers 312, and the type of mirror coatings used for the waveguides, getting this high range of efficiencies across the EPE and the OC may not be possible.

Accordingly, described herein are example reflective-based waveguide configurations/architectures that provide for improved light extraction efficiency, and thus pupil efficiency, while also providing for a less visible coupler configuration. As described in greater detail below, in at least some embodiments, a reflective-based waveguide for implementation in a near-eye display system utilizes holographically recorded one-dimensional (1D) Bragg optical devices (e.g., gratings, mirrors, or a combination thereof) as the mirrors/facets in the waveguide. The 1D Bragg optical devices typically are dispersion-free, so they are unlikely to suffer from cross-talk issues as often found in conventional multiplexed holographic waveguide architectures. Further, the 1D Bragg optical devices, in at least some embodiments, are spectrally and angularly multiplexed. Therefore, in at least some embodiments, the 1D Bragg optical devices are made to be highly efficient in the angle and wavelength ranges of interest for the near-eye display system and effectively transparent outside these angle and wavelength ranges, which in turn significantly reduces the see-through artifacts typically caused by conventional facets/couplers of a waveguide.

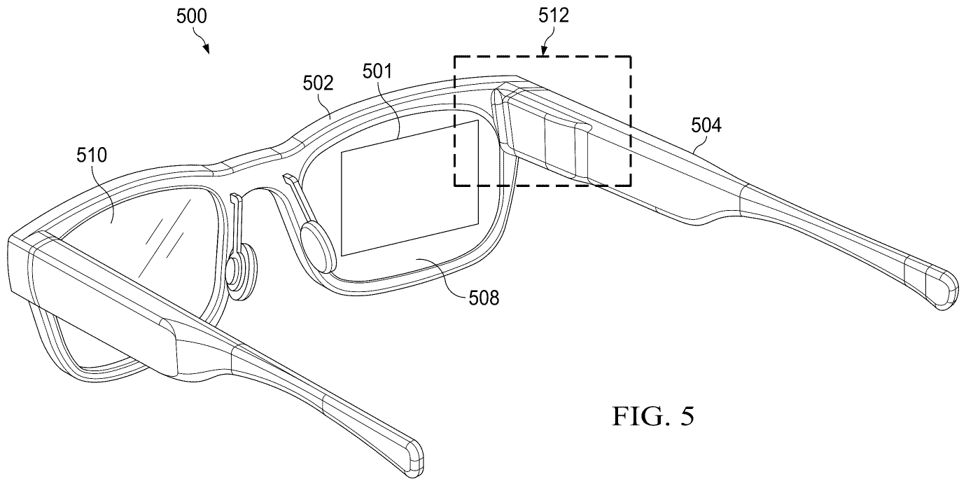

FIG. 5 illustrates an example display system 500 capable of implementing one or more of the waveguide configurations described herein. It should be noted that, although the apparatuses and techniques described herein are not limited to this particular example, but instead may be implemented in any of a variety of display systems using the guidelines provided herein. For example, although the display system 500 is shown as implementing an integrated laser projection system, the apparatuses and techniques described herein apply to any type of projection system, such as a laser-based projection system, a digital light processing (DLP) projection system, a liquid crystal on silicon (LCoS) projection system, a micro-light emitting diode projection system, and the like.

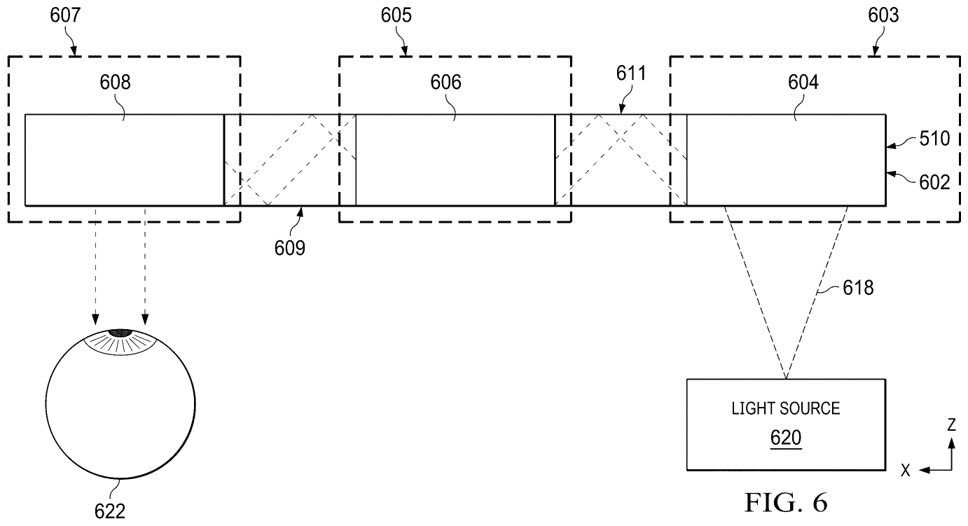

In at least some embodiments, the display system 500 comprises a support structure 502 (e.g., an eyeglass frame) that includes an arm 504, which houses an image source, such as laser projection system, micro-display (e.g., micro-light emitting diode (LED) display), or other light engine configured to project display light representative of images toward the eye of a user such that the user perceives the projected images as being displayed in a field of view (FOV) area 501 of a display at one or both of lens elements 508, 510. In the depicted embodiment, the display system 500 is a near-eye display system that includes the support structure 502 configured to be worn on the head of a user and has a general shape and appearance of an eyeglasses frame. The support structure 502 includes various components to facilitate the projection of such images toward the eye of the user, such as a laser projector, an optical scanner, and a waveguide, such as the waveguide 602 described below with respect to FIG. 6 to FIG. 11. In at least some embodiments, the support structure 502 further includes various sensors, such as one or more front-facing cameras, rear-facing cameras, other light sensors, motion sensors, accelerometers, and the like. The support structure 502 further, in at least some embodiments, includes one or more radio frequency (RF) interfaces or other wireless interfaces, such as a Bluetooth™ interface, a Wireless Fidelity (WiFi) interface, and the like.

Further, in at least some embodiments, the support structure 502 includes one or more batteries or other portable power sources for supplying power to the electrical components of the display system 500. In at least some embodiments, some or all of these components of the display system 500 are fully or partially contained within an inner volume of support structure 502, such as within the arm 504 in region 512 of the support structure 502. It should be noted that while an example form factor is depicted, it will be appreciated that in other embodiments, the display system 500 may have a different shape and appearance from the eyeglasses frame depicted in FIG. 5.

One or both of the lens elements 508, 510 are used by the display system 500 to provide an augmented reality (AR) or a mixed reality (MR) display in which rendered graphical content is superimposed over or otherwise provided in conjunction with a real-world view as perceived by the user through the lens elements 508, 510. For example, laser light or other display light is used to form a perceptible image or series of images that are projected onto the eye of the user via a series of optical elements, such as a waveguide (e.g., the waveguide 602) formed at least partially in the corresponding lens element, one or more scan mirrors, and one or more optical relays. Thus, one or both of the lens elements 508, 510 include at least a portion of a waveguide that routes display light received by an incoupler (e.g., IC 604 of FIG. 6) or multiple input couplers, of the waveguide to an outcoupler (e.g., OC 608 of FIG. 6) of the waveguide, which outputs the display light toward an eye of a user of the display system 500. Additionally, the waveguide employs an exit pupil expander (e.g., the EPE 606 of FIG. 6) in the light path between the IC and OC, or in combination with the OC, in order to increase the dimensions of the display exit pupil. The display light is modulated and scanned onto the eye of the user such that the user perceives the display light as an image. In addition, each of the lens elements 508, 510 is sufficiently transparent to allow a user to see through the lens elements to provide a field of view of the user's real-world environment such that the image appears superimposed over at least a portion of the real-world environment.

In at least some embodiments, the projector is a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The projector, in at least some embodiments, includes multiple laser diodes (e.g., a red laser diode, a green laser diode, and a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In at least some embodiments, the controller controls a scan area size and scan area location for the projector and is communicatively coupled to a processor (not shown) that generates content to be displayed at the display system 500. The projector scans light over a variable area, designated the FOV area 501, of the display system 500. The scan area size corresponds to the size of the FOV area 501, and the scan area location corresponds to a region of one of the lens elements 508, 510 at which the FOV area 501 is visible to the user. Generally, it is desirable for a display to have a wide FOV to accommodate the outcoupling of light across a wide range of angles. The range of different user eye positions that will be able to see the display is referred to as the eyebox of the display.

FIG. 6 depicts a cross-section view of an implementation of a lens element 510 of a display system, such as display system 500, which, in at least some embodiments, comprises a waveguide 602. Note that for purposes of illustration, at least some dimensions in the Z-direction are exaggerated for improved visibility of the represented aspects. In this example implementation, the waveguide 602 is a reflective-based waveguide comprising an IC 604 in a first region 603 of the waveguide 602, an EPE 606 in a second region 605 of the waveguide 602, and an OC 608 in a third region 607 of the waveguide 602. The EPE 606 is disposed in a light propagation path between the IC 604 and the OC 608. It should be understood that FIG. 6 shows each of the IC 604, EPE 606, and OC 608 extending from a first side of the waveguide to a second opposite side of the waveguide 602 for illustrations purposes and other configurations are applicable as well. For example, one or more of the IC 604, EPE 606, and OC 608 can be disposed at a single side of the waveguide 602, at the interface of two layers or substrates of the waveguide 602, or the like.

In at least some embodiments, depending on the configuration of the waveguide 602, one or more of the IC 604, EPE 606, and the OC 608 are implemented at different locations within or on the waveguide 602. In one example, the IC 604 and OC 608 are situated on a first side of the waveguide 602 and the EPE 606 is situated on a second side of the waveguide 602 that is opposite the first side. For example, the IC 604 and the OC 608 are implemented on the eye-facing side 609 of the lens element 510 and the EPE 606 is implemented on the world-facing side 611 of the lens element 510 that is opposite the eye-facing side 609, or vice versa. In another example the IC 604 and EPE 606 are situated on a first side of the waveguide 602 and the OC 608 is situated on a second side of the waveguide 602 that is opposite the first side. For example, the IC 604 and the EPE 606 are implemented on the eye-facing side 609 of the lens element 510 and the OC 608 is implemented on the world-facing side 611 of the lens element 510 that is opposite the eye-facing side 609, or vice versa. In a further example, the EPE 606 and the OC 608 are located on the same side of the waveguide opposite the side of the waveguide 602 at which the IC 604 is situated.

In at least some embodiments, the IC 604 includes one or more facets or reflective surfaces. The IC 604, in at least some embodiments, has a substantially rectangular profile and is defined by a smaller dimension (i.e., width) and a larger orthogonal dimension (i.e., length). In at least some embodiments, the IC 604 is configured to receive display light 618 from a light source 620 and direct the display light 618 into the waveguide 602. The display light 618 is propagated (through total internal reflection (TIR) in this example) toward the EPE 606, which is situated between the IC 604 and the OC 608. The EPE 606 reflects the incident display light for exit pupil expansion purposes and the resulting light is propagated to the OC 608, which outputs the display light 618 toward the eye (s0 622 of the user. In at least some embodiments, the IC 604 and the EPE 606 each direct incident light in a particular direction depending on the angle of incidence of the incident light and the structural aspects of the IC 604 and EPE 606.

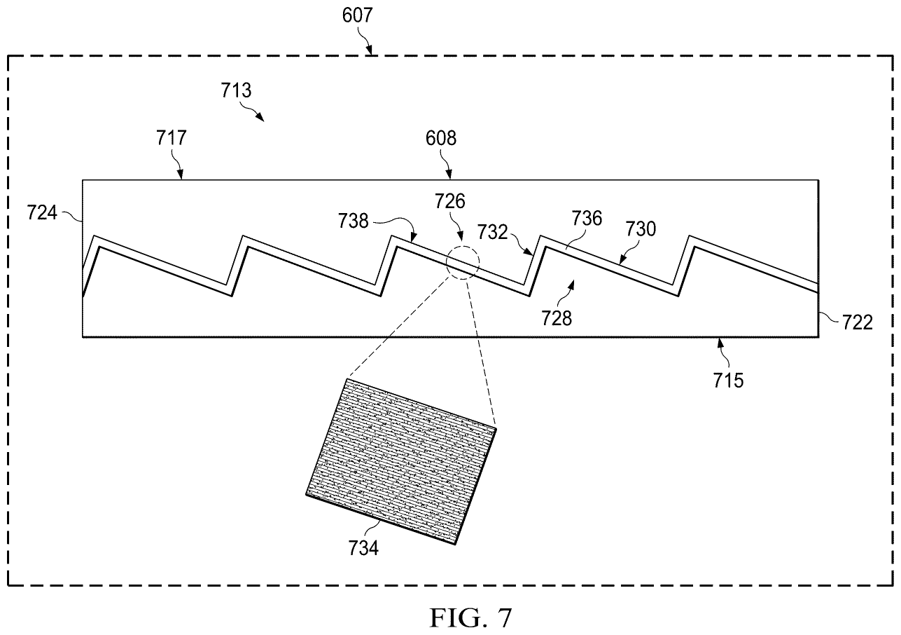

In at least some embodiments, one or more of the EPE 606 and the OC 608 comprises a plurality of facets/couplers. For example, FIG. 7 shows a cross-section of the waveguide region 607 comprising the OC 608. It should be understood that the description of FIG. 7 is also applicable to the EPE 606 as well. In the example of FIG. 7, the OC 608 is a sandwiched or mated structure 713 comprising a first waveguide portion 722, such as a first optic layer, and a second waveguide portion 724, such as a second optic layer, opposite the first waveguide portion 722 in the third region 607 of the waveguide 602. Each of the first waveguide portion 722 and the second waveguide portion 724, in at least some embodiments, is a separate substrate forming the waveguide 602, a portion of a separate substrate forming the waveguide 602, a separate layer(s) within one or more substrates of the waveguide 602, a portion of a separate layer(s) within one or more substrates of the waveguide 602, or the like. Also, although FIG. 7 shows each of the first waveguide portion 722 and second waveguide portion 724 as being a single layer, in other embodiments, one or more of the first waveguide portion 722 and second waveguide portion 724 comprises multiple layers.

The first waveguide portion 722 and the second waveguide portion 724, in at least some embodiments, comprise a material that is optically transparent in the wavelength range of interest and meets other application requirements such as rigidity, durability, scratch resistance, and the like. In at least some embodiments, both the first waveguide portion 722 and the second waveguide portion 724 comprise a material made of an optical grade acrylic. However, other materials are applicable as well, such as polycarbonate, glass, or any other suitable waveguide-based material. In at least some embodiments, the first waveguide portion 722 and the second waveguide portion 724 comprise the same material. In other embodiments, the first waveguide portion 722 and the second waveguide portion 724 comprise different materials having matched refractive indices.

An embedded structure is formed within the OC 608 and is positioned between a surface 715 of the first waveguide portion 722 and an opposite surface 717 of the second waveguide portion 724. The embedded structure includes a reflective array 726 comprising a plurality of wedges 728. In at least some embodiments, each wedge 728 is a ridge with a wedge-shaped cross-section, although other configurations are applicable as well. Each wedge 728 includes a primary facet 730 that is at least partially reflective and a substantially transmissive (i.e., non-reflective) secondary facet 732. In at least some embodiments, each wedge 728 also includes a substantially transmissive (i.e., non-reflective) plateau facet (not shown) between the primary facet 730 and the secondary facet 732. It should be understood that the OC 608 is not limited to the distance between the wedges 728 or the number of primary facets 730 and secondary facets 732 shown in FIG. 7. In at least some embodiments, the reflective array 726 and its features (e.g., wedges 728, primary facets 730, and second facets 732) are formed on or at the first waveguide portion 722. In these embodiments, the second waveguide portion 724 comprises corresponding features (e.g., wedges 728, primary facets 730, and second facets 732) that mate with the features of the first waveguide portion 722. In other embodiments, the reflective array 726 and its features (e.g., wedges 728, primary facets 730, and second facets 732) are formed on or at the second waveguide portion 724. In these and other embodiments, the first waveguide portion 722 comprises corresponding features (e.g., wedges 728, primary facets 730, and second facets 732) that mate with the features of the second waveguide portion 724.

As described above, conventional reflective-based waveguides typically implement mirrors on each of the facets of the EPE and OC resulting in facets/couplers that are highly visible and distracting to the user. However, the waveguide 602 of one or more embodiments overcomes these issues and provides for improved light extraction efficiency, and thus pupil efficiency, by implementing one or more holograph-based reflective couplers 734 (also referred to herein as “reflective couplers 734” for brevity), such as 1D Bragg optical devices (e.g., gratings, mirrors, or a combination thereof), at one or more of the primary facets 730 of the OC 608 (and the EPE 606). For example, FIG. 7 shows that, in at least some embodiments, a photopolymer layer 736 is disposed between the first waveguide portion 722 and the second waveguide portion 724. In at least some embodiments, the photopolymer layer 736 is disposed over and in contact with each of the primary facets 730, secondary facets 732, and plateau facets (if implemented) of the first waveguide portion 722. In other embodiments, the photopolymer layer 736 is alternatively (or additionally) disposed over and in contact with each of the primary facets, secondary facets, and plateau facets (if implemented) of the second waveguide portion 724. One or more portions 738 of the photopolymer layer 736 corresponding to one or more primary facets 730 of the first waveguide portion 722 (or second waveguide portion 724) comprises one or more holographically recorded reflective couplers 734, such as 1D Bragg optical devices, which act as mirrors/couplers for the OC 608 (or EPE 606). Stated differently, one or more reflective couplers 734 are disposed between the first waveguide portion 722 and the second waveguide portion 724 on complementary portions of the first waveguide portion 722 and the second waveguide portion 724.

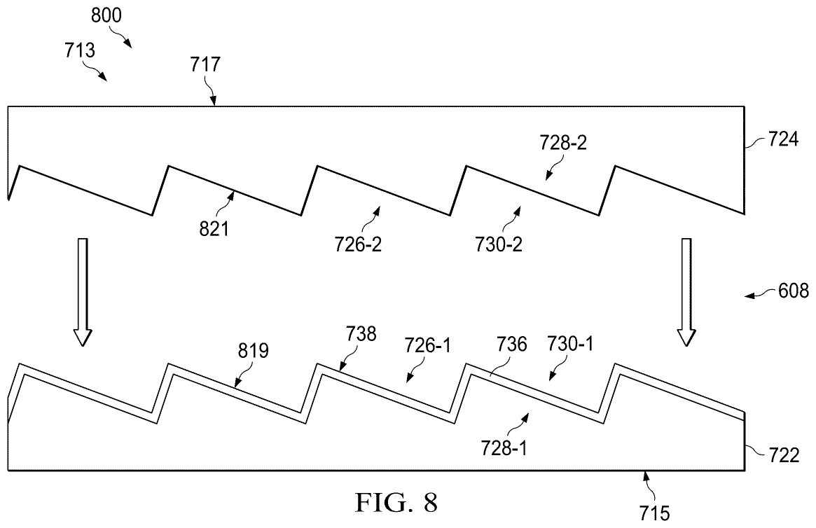

FIG. 8 illustrates one example of a fabrication process 800 for the sandwiched/mated structure 713 of the OC 608 (or EPE 606) of FIG. 7. It should be understood that the OC 608 (or EPE 606) of one or more embodiments is not limited to the fabrication process described below with respect to FIG. 8 and other fabrication processes are applicable as well. As described above, the OC 608 (or the EPE 606) includes a first waveguide portion 722 and a second waveguide portion 724. The first waveguide portion 722 includes a first surface 715 and a second (or mating) surface 819 comprising a first array portion 726-1. The first array portion 726-1, in at least some embodiments, includes a first plurality of wedges 728-1 in a pattern that is complementary to the pattern of a second plurality of wedges 728-2 in a second array portion 726-2 of the second waveguide portion 724 (that is, the pattern of the first plurality of wedges 728-1 and the pattern of the second plurality of wedges 728-2 are complementary patterns), so that the wedges 728-2 in the second array portion 726-2 mesh with the corresponding wedges 728-1 in the first array portion 726-1 when mated. In the first waveguide portion 722, the primary facets 730-1 of the first array portion 726-1 are at least partially reflective and the secondary facets 732-1 (and plateau facets if implemented) are substantially transmissive (i.e., non-reflective). In at least some embodiments, all primary facets 730-1 have the same reflectivity but, in other embodiments, there are groups of primary facets 730-1 having different reflectivities.

The second waveguide portion 724, in at least some embodiments, includes a first surface 717 and a second or mating surface 721 comprising a second array portion 726-2. The second array portion 726-2, in at least some embodiments, includes a first plurality of wedges 728-2 in a pattern that is complementary to the pattern of the first plurality of wedges 728-1 in the first array portion 726-1 of the first waveguide portion 722, so that the wedges 728-1 in the first array portion 726-1 mesh with the corresponding wedges 728-2 in the second array portion 826-2 when mated.

In at least some embodiments, a photopolymer layer 736 or other layer comprising a material(s) capable of holographic recording is formed/deposited over the first array portion 726-1. For example, in at least some embodiments, a thin-film deposition method, such as physical vapor deposition (PVD), chemical vapor deposition (CVD), or their varieties, is used to deposit a conformal photopolymer layer 736 over the first array portion 726-1. Stated differently, the photopolymer layer 736 is formed on and in contact with the primary facets 730-1 and the secondary facets 732-1 (and plateau facets if implemented). In other embodiments, the photopolymer layer 736 is conformally formed over the second array portion 726-2 of the second waveguide portion 724. Alternatively, a separate photopolymer layer 736 is formed over each of the first array portion 826-1 of the first waveguide portion 722 and the second array portion 726-2 of the second waveguide portion 724.

The first waveguide portion 722 and the second waveguide portion 724 are joined by adhering the mating surface 819 of the first waveguide portion 722 to the mating surface 821 of the second waveguide portion 724. When the first waveguide portion 722 and the second waveguide portion 724 are joined, the mating surface 819 of the first waveguide portion 722 is in contact with the mating surface 821 of the second waveguide portion 724. The reflective array 726 of FIG. 7, in at least some embodiments, is formed by the mating surface 819 of the first waveguide portion 722 and the mating surface 821 of the second waveguide portion 824. For example, when the first array portion 726-1 and the second array portion 726-2 are mated, the primary facets 730-1 of the first array portion 726-1 comprising a corresponding portion of the photopolymer layer 836 are in contact with the primary facets 730-2 of the second array portion 726-2, and the secondary facets 732-1 of the first array portion 726-1 comprising a corresponding portion of the photopolymer layer 736 are in contact with the secondary facets 732-2 of the second array portion 726-2. In at least some embodiments, the first waveguide portion 722 and the second waveguide portion 724 are held together along the mating surfaces using index-matched optical adhesives that match the refractive indices of the first waveguide portion 722 and the second waveguide portion 724.

After the first waveguide portion 822 and the second waveguide portion 824 have been mated, one or more holograph-based reflective couplers 734 (FIG. 7) are formed in one or more portions 738 of the photopolymer layer 736 corresponding to one or more primary facets 730-1 of the first waveguide portion 722, or one or more primary facets 730-2 of the second waveguide portion 724 in embodiments where the photopolymer layer 736 is formed on the second waveguide portion 724. In at least some embodiments, the reflective couplers 734 are holographically recorded in the portions 738 of the photopolymer layer 736 using one or more holographic recording processes. For example, the photopolymer layer 736 is controllably exposed/illuminated with ultraviolet (UV) light or visible in the spatial shape of a standing wave pattern such that multiple UV light beams (e.g., two light beams) are superimposed in the photopolymer layer 836 having different propagation directions. The angle between the multiple light beams, along with the optical wavelength and the refractive index of the photopolymer material, determines the period obtained in the interference pattern forming the holograph-based reflective couplers 734 (e.g., 1D Bragg optical devices). In at least some embodiments, the reflective couplers 734 are holographically recorded into the portions 738 of the photopolymer layer 736 prior to mating the first waveguide portion 722 with the second waveguide portion 724.

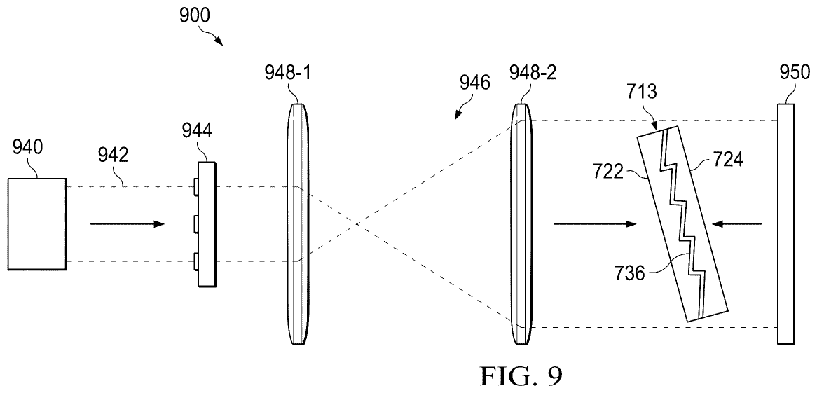

FIG. 9 shows one example of a system 900 for holographically recording the reflective couplers 734 in the photopolymer layer 736 of the OC 608 (or EPE 606). In this example, the system 900 includes one or more light sources 940 that generate and output one or more light beams 942. An amplitude mask 944, which comprises a pattern corresponding to the 1D Bragg optical device, is applied to the incident light beam 942 to spatially modulate the incident light beam 942 according to the pattern. A relay system 946, such as a 4f relay system, comprising multiple lenses 948 (illustrated as lens 948-1 and lens 948-2) magnifies the light beam output by the amplitude mask 944. The magnified light beam 942 is then imaged onto the photopolymer layer 736 of one or both of the first waveguide portion 722 or the second waveguide portion 724 to form holograph-based reflective couplers 734, such as 1D Bragg optical devices, therein. In at least some embodiments, the reflective couplers 734 are holographically recorded into the portions 738 of the photopolymer layer 736 prior to mating the first waveguide portion 722 with the second waveguide portion 724. A mirror 950, in at least some embodiments, reflects at least a portion of the magnified light beam 942 back into the sandwiched/mated structure 713 of the OC 608 (or EPE 606). In at least some embodiments, the waveguide substrate comprising the sandwiched/mated structure 713 of the OC 608 (or EPE 606) is tilted so that the holograph-based reflective couplers 734 of the waveguide 602 are formed so as to be normal to the waveguide 602.

The holograph-based reflective couplers 734, in at least some embodiments, are dispersion-free, so they are unlikely to suffer from cross-talk issues as often found in conventional multiplexed holographic waveguide architectures. Further, the holograph-based reflective couplers 734, in at least some embodiments, are spectrally and angularly multiplexed. Therefore, in at least some embodiments, the holograph-based reflective couplers 734 are made to be highly efficient in the angle and wavelength ranges of interest for the display system 500 and effectively transparent outside these angle and wavelength ranges, which in turn significantly reduces the see-through artifacts typically caused by conventional facets/couplers of a waveguide.

In at least some embodiment, spatio-spectral multiplexing is utilized to achieve uniform extraction over the entire eyebox of the display system 500. In this approach, each individual coupler of the EPE 606 and OC 608 is tuned to couple a small fraction of the entire broadband spectrum of the light incident on it, with each of these couplers being highly efficient but narrowband. As the different regions of the holograph-based reflective couplers 734 interact only with a specific part of the spectrum, there is no need for gradually increasing the efficiency of the gratings (or other optical devices such as mirrors or mirror/grating combinations) from one side of the coupler to the other. Moreover, in at least some embodiments, a frequency comb of spectrally-selective reflective couplers 734 are recorded for one or both of the EPE 606 or the OC 608. Stated differently, each of the couplers is, for example, composed of several narrowband (e.g., 1 nanometer to 20 nanometers) 1D Bragg optical device recorded for wavelengths spanning the source bandwidth to form a frequency comb. The frequency comb is offset from one coupler to another coupler such that two corresponding couplers do not interact with the same angular and spectral slice. This offset can be, for example, one half-width-half-max. However, other offsets are applicable as well.

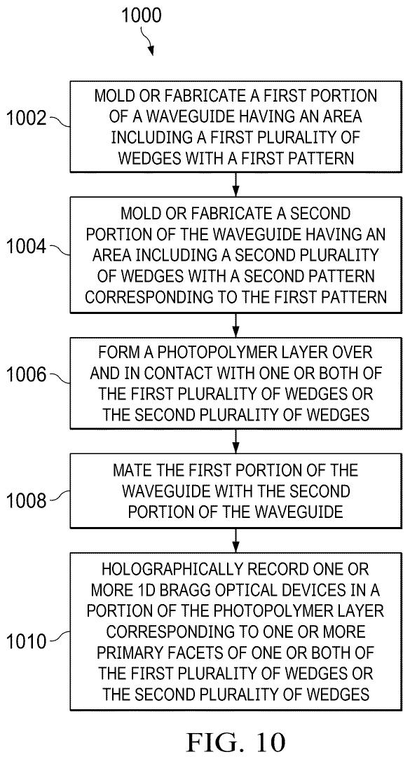

FIG. 10 illustrates, in flow chart form, one example method 1100 of fabricating a reflective-base waveguide 602 or a portion thereof comprising one or both of an EPE 606 or an OC 608 comprising the holograph-based reflective couplers 734 described herein. It should be understood that the processes described below with respect to method 1000 have been described above in greater detail with reference to FIG. 6 to FIG. 9. The method 1000 is not limited to the sequence of operations shown in FIG. 10, as at least some of the operations can be performed in parallel or in a different sequence. Moreover, in at least some embodiments, the method 1000 can include one or more different operations than those shown in FIG. 10. Also, the method 1000 is applicable to forming one or both of the EPE 606 or the OC 608 of the waveguide 602.

At block 1002, a first waveguide portion 722 (e.g., optic layer) of a waveguide 602 having an area including a first plurality of wedges (ridges) 728-1 with a first pattern is molded or fabricated. At block 1004, a second waveguide portion 724 (e.g., optic layer) of the waveguide 602 having an area including a second plurality of wedges (ridges) 728-2 with a second pattern corresponding to the first pattern is molded or fabricated. Stated differently, the ridges of the first optic layer are complementary to the ridges of the second optic layer of the waveguide 602 (that is, the ridges of the first optic layer and the ridges of the second optic layer are complementary ridges). At block 1006, a photopolymer layer 736 is formed over and in contact with one or both of the first plurality of wedges 728-1 or the second plurality of wedges 728-2. At block 1008, the first waveguide portion 722 of the waveguide is mated with the second waveguide portion 724 of the waveguide 602. At block 1010, one or more reflective couplers 734 are holographically recorded in a portion 738 of the photopolymer layer 736 corresponding to one or more primary facets 730 of one or both of the first plurality of wedges 728-1 or the second plurality of wedges 728-2. It at least some embodiments, the holographic recording processes at block 1010 are performed prior to mating the first waveguide portion 722 of the waveguide with the second waveguide portion 724 of the waveguide 602 at block 1008.

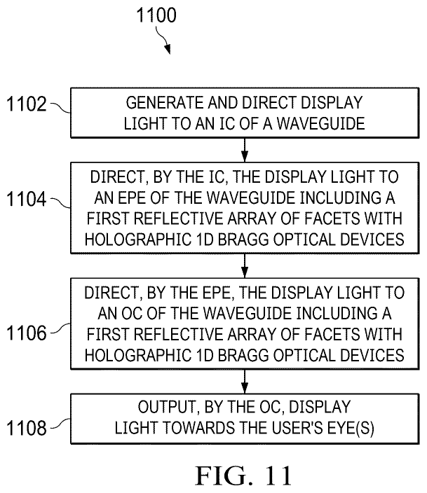

FIG. 11 illustrates, in flow chart form, one example method 1100 of operating a near-eye display system, such as the display system 500 of FIG. 5, to project display light from a display source toward an eye of a user. The method 1100 is not limited to the sequence of operations shown in FIG. 11, as at least some of the operations can be performed in parallel or in a different sequence. Moreover, in at least some embodiments, the method 1100 can include one or more different operations than those shown in FIG. 11.

At block 1102, a light source 620 generates and directs display light 618 to an IC 604 of a waveguide 602. At block 1104, the IC 604 directs the display light 618 to an EPE 606 of the waveguide 602. The EPE 606 includes a reflective array 726 comprising a plurality of facets 730 implementing one of more holograph-based reflective couplers 734. At block 1106, the EPE 606 directs the display light 618 to an OC 608 of the waveguide 602 also including a reflective array 726 comprising a plurality of facets 730 implementing one of more holograph-based reflective couplers 734. For example, one or more of the holograph-based reflective couplers 734 of the EPE 606 reflect an incident light beam of the display light 718 to OC 608. At block 1108, the OC 608 outputs the display light 618 to the user's eye(s). For example, one or more of the holograph-based reflective couplers 734 of the OC 608 reflect an incident light beam of the display light 618 to the user's eye(s).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A waveguide comprising:
an incoupler;
an outcoupler; and
an exit pupil expander disposed in a light propagation path between the incoupler and the outcoupler,
wherein at least one of the outcoupler or the exit pupil expander comprises one or more holograph-based reflective couplers.

2. The waveguide of claim 1, wherein the one or more holograph-based reflective couplers are one-dimension Bragg optical devices.

3. The waveguide of claim 1, wherein the one or more holograph-based reflective couplers are disposed within a photopolymer layer of the at least one of the outcoupler or the exit pupil expander.

4. The waveguide of claim 1, wherein the waveguide further comprises a layer of photopolymer with the one or more holograph-based reflective couplers disposed between two molded optic layers with complementary ridges.

5. The waveguide of claim 1, wherein at least one of the outcoupler or the exit pupil expander comprises a reflective array comprising a plurality of facets.

6. The waveguide of claim 5, wherein the one or more holograph-based reflective couplers are formed on the plurality of facets.

7. The waveguide of claim 5, wherein at least one of the outcoupler or the exit pupil expander further comprises:
a first waveguide portion comprising a first portion of the reflective array; and
a second waveguide portion comprising a second portion of the reflective array,
wherein the first waveguide portion is mated with the second waveguide portion.

8. The waveguide of claim 7, wherein the first waveguide portion is adhered to the second waveguide portion.

9. The waveguide of claim 7, wherein at least one of the outcoupler or the exit pupil expander further comprises:
a photopolymer layer disposed between the first portion of the reflective array and the second portion of the reflective array.

10. The waveguide of claim 9, wherein the first waveguide portion comprises a first plurality of wedges-including a first plurality of primary facets and a first plurality of secondary facets, and wherein the second waveguide portion comprises a second plurality of wedges, corresponding to the first plurality of wedges, including a second plurality of primary facets and a second plurality of secondary facets.

11. The waveguide of claim 10, wherein the photopolymer layer is disposed on at least one of the first plurality of primary facets and the second plurality of primary facets or the second plurality of primary facets and the second plurality of secondary facets.

12. The waveguide of claim 10, wherein the one or more holograph-based reflective couplers are formed in one or more portions of the photopolymer layer disposed on one or more facets of at least one of the first plurality of primary facets or the second plurality of primary facets.

13. The waveguide of claim 1, wherein the one or more holograph-based reflective couplers are spectrally and angularly multiplexed.

14. The waveguide of claim 1, wherein the one or more holograph-based reflective couplers each comprise a frequency comb including a plurality of narrowband one-dimensional Bragg optical devices.

15. The waveguide of claim 1, wherein the one or more holograph-based reflective couplers each are each tuned to a fraction of a broadband spectrum of light.

16. The waveguide of claim 1, wherein the outcoupler comprises the one or more holograph-based reflective couplers.

17. The waveguide of claim 1, wherein the exit pupil expander comprises the one or more holograph-based reflective couplers.

18. A waveguide comprising:
an incoupler;
an outcoupler; and
an exit pupil expander disposed in a light propagation path between the incoupler and the outcoupler,
wherein at least one of the outcoupler or the exit pupil expander comprises:
a first optic layer;
a second optic layer; and
a plurality of holograph-based reflective couplers disposed between the first optic layer and the second optic layer on complementary portions of the first optic layer and the second optic layer.

19. The waveguide of claim 18, wherein the complementary portions of the first optic layer and the second optic layer are ridges.

20. A near-eye display system comprising:
an eyeglass frame;
an ophthalmic lens implementing the waveguide of claim 1; and
a display source to project display light toward the incoupler.

21. (canceled)
